(19) United States
(12) Patent Application Publication
(10) Pub. No.: US 2008/0089243 A1
(43) Pub. Date: Apr. 17, 2008

(54) Managing An Over-Subscribed Data Communication Network

(76) Inventors: David D. Jameson, Rowlett, TX (US); Jeffrey A. Ross, Plano, TX (US)

Correspondence Address: BAKER BOTTS L.L.P., 2001 ROSS AVENUE, SUITE 600, DALLAS, TX, 75201-2980, US

(21) Appl. No.: 11/550,105

(22) Filed: Oct. 17, 2006

(51) Int. Cl. H04L 12/28

(52) U.S. Cl. 370/255; 370/401

(57) ABSTRACT

Managing a network involves accessing a network description of a network that includes links. Generation of a network view of the network is initiated according to the network description. One or more candidate links are identified, where a candidate link represents a link that is a candidate for partitioning the network. Graphical identification of the candidate links is initiated.

### TECHNICAL FIELD

This invention relates generally to the field of network management and more specifically to managing an over-subscribed data communication network.

### BACKGROUND

Communication networks may communicate traffic over a data communication channel (DCC) of a link. In certain situations, a network of data communication channels may carry too many connections, resulting in an over-subscribed channel. The over-subscribed channel may fail to communicate data over various connections. It is generally desirable to communicate data among the subscribed connections.

### SUMMARY OF THE DISCLOSURE

In accordance with the present invention, disadvantages and problems associated with previous techniques for managing an over-subscribed data communication network may be reduced or eliminated.

According to one embodiment of the present invention, managing a network involves accessing a network description of a network that includes links. Generation of a network view of the network is initiated according to the network description. One or more candidate links are identified, where a candidate link represents a link that is a candidate for partitioning the network. Graphical identification of the candidate links is initiated.

Certain embodiments of the invention may provide one or more technical advantages. A technical advantage of one embodiment may be that a network management system may initiate graphical identification of candidate links at which a network may be partitioned. The network may be partitioned in order to manage over-subscribed data communication channels.

Another technical advantage of one embodiment may be that a link with adjacent network elements that are serviced by different gateway network elements may be identified as a candidate link. Such candidate link may provide an effective point at which to partition the network.

Another technical advantage of one embodiment may be that a user may be provided with an option to manage candidate links. As an example, the user may be able to request that a data communication channel of a candidate link be disabled to partition the network. As another example, the user may be able to request that the data communication channels of candidate links be passed through a network element to partition the network.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating one embodiment of a network that includes a network management system (NMS) that may operate according to one embodiment of the invention; and

FIG. 2 illustrates a method for managing an over-subscribed data communication network that may be used with the network of FIG. 1.

### DETAILED DESCRIPTION OF THE DRAWINGS

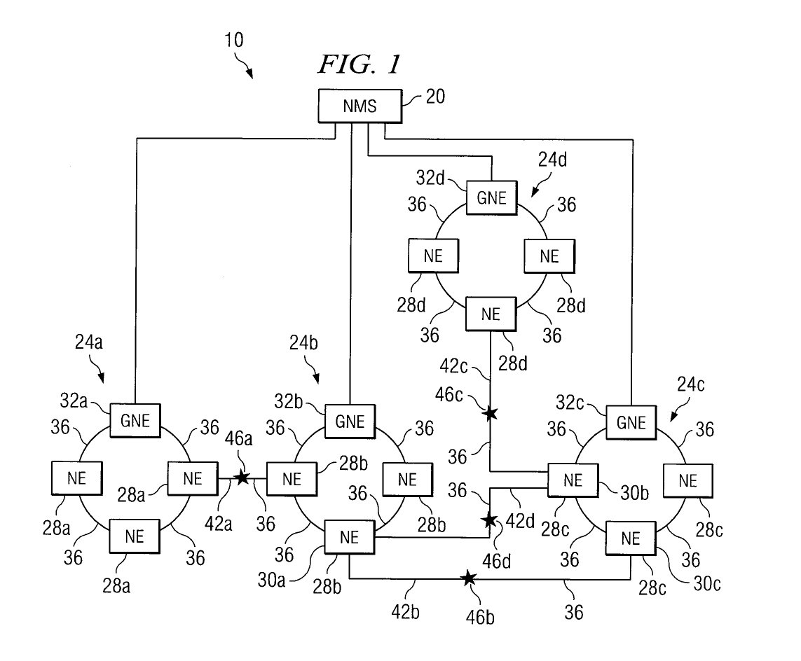

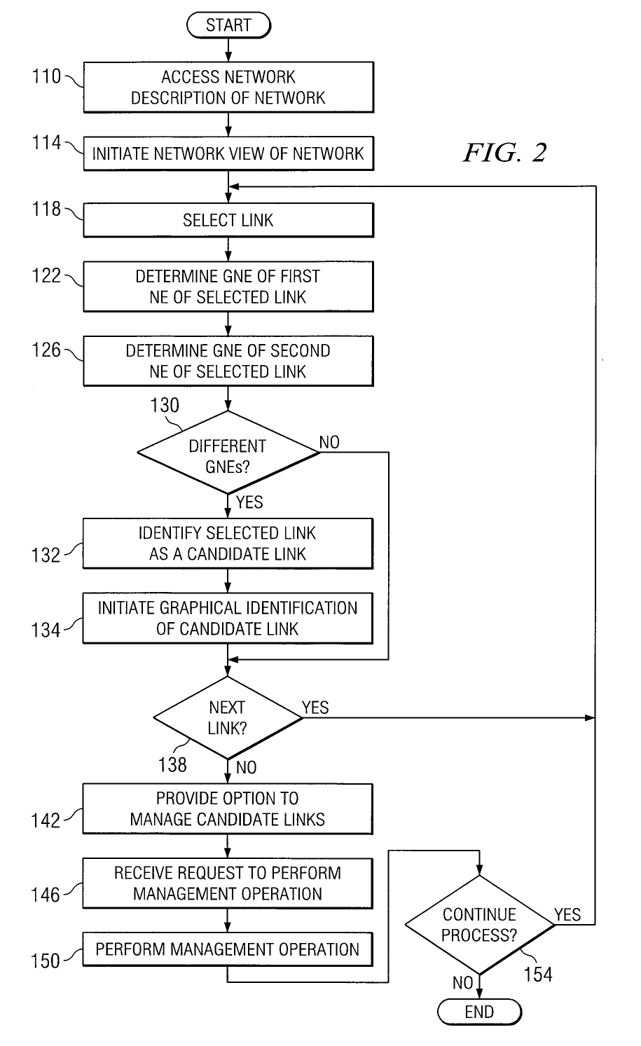

Embodiments of the present invention and its advantages are best understood by referring to FIGS. 1 and 2 of the drawings, like numerals being used for like and corresponding parts of the various drawings.

FIG. 1 is a block diagram illustrating one embodiment of a network 10 that includes a network management system (NMS) 26 that may operate according to one embodiment of the invention. According to the embodiment, network management system 26 may initiate graphical identification of candidate links at which network 10 may be partitioned in order to manage over-subscribed data communication channels. A link with adjacent network elements (NEs) 28 that are serviced by different gateway network elements (GNEs) 32 may be identified as a candidate link 42. Such candidate link 42 may provide an effective point at which to partition network 10.

According to the embodiment, a user may be provided with an option to manage candidate links 42. As an example, the user may be able to request that the data communication channel of a candidate link be disabled to partition the network. As another example, the user may be able to request that the data communication channels of candidate links be passed through a network element to partition the network.

According to one embodiment, network 10 may represent a communication network that allows components to communicate with other components. A communication network may comprise all or a portion of one or more of the following: a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of any of the preceding.

According to one embodiment, network 10 may include one or more network rings. A network ring may refer to a network of communication devices that has a ring topology. According to one embodiment, a network ring may comprise an optical fiber ring. A network ring may utilize protocols such as a resilient packet ring (RPR) protocol. For example, a network ring may utilize RPR/Ethernet or RPR/Synchronous Optical Network (SONET).

Network 10 may communicate information. Information may refer to voice, data, text, audio, video, multimedia, control, signaling, other information, or any combination of any of the preceding. Information may be communicated in packets. A packet may comprise a bundle of data organized in a specific way for transmission.

Network 10 may communicate using signals. A signal may refer to an optical signal transmitted as light pulses. As an example, an optical signal may have a frequency of approximately 1550 nanometers and a data rate of approximately 2.4, 10, 40, or over 40 gigabits per second.

Network 10 may utilize communication protocols and technologies to communicate. Examples of communication protocols and technologies include those set by the Institute of Electrical and Electronics Engineers, Inc. (IEEE) 802.xx standards, the International Telecommunications Union (ITU-T) standards, the European Telecommunications Standards Institute (ETSI) standards, the Internet Engineering Task Force (IETF) standards, or other standards.

According to one embodiment, a user may access at least a portion of network 10. A user may refer to an entity, such as one or more people, a company or other organization, one or more computing devices, and/or other entity that may communicate using network 10. A user may have a user identifier and a user account. A user identifier uniquely identifies the user, and a user account records information about the user.

Network 10 may include one or more components operable to perform the operations of network 10. A component may include any suitable arrangement of elements operable to perform the operations of the component, for example, an interface, logic, memory, other suitable element, or any suitable combination of any of the preceding.

An interface may receive input for the component, send output from the component, process the input and/or output, perform other suitable operation, or perform any suitable combination of any of the preceding. An interface may comprise one or more ports and/or conversion software.

A memory may store information. A memory may comprise one or more of any of the following: a Random Access Memory (RAM), a Read Only Memory (ROM), a magnetic disk, a Compact Disk (CD), a Digital Video Disk (DVD), a media storage, any other suitable information storage medium, or any suitable combination of any of the preceding.

Logic may process information for the component by receiving input and executing instructions to generate output from the input. Logic may include hardware, software, other logic, or any suitable combination of any of the preceding. Certain logic, such as a processor, may manage the operation of a component. Examples of a processor may include one or more computers, one or more microprocessors, one or more applications, other logic operable to manage the operation of a component, or any suitable combination of any of the preceding.

According to the illustrated embodiment, network 10 includes one or more subnetworks 24 coupled to a network management system (NMS) 26 as shown. A subnetwork 24 may represent a network comprising a management communication area serviced by a gateway network element 32. According to one embodiment, subnetwork 24 may represent an optical network ring. In the embodiment, a subnetwork 24 may operate efficiently if it has less than a maximum number of network elements 28.

A subnetwork 24 may include one or more network elements 28. A network element 32 may represent any suitable device operable to communicate information within network 10. Examples of network elements 32 include add-drop multiplexers (ADMs), multi-service provisioning platforms (MSPPs), multi-service switching platforms (MSSPs), dense wavelength division multiplexers (DWDMs), access gateways, endpoints, softswitch servers, trunk gateways, access service providers, Internet service providers, or other device operable to communicate information within network 10.

Network elements 28 comprise a gateway network element 32. Gateway network element 32 may represent a network element that communicates with network management system 26 in order to manage network 10. A network element may report to the gateway network element 32 that services the network element 28. According to one embodiment, a gateway network element 32 of a subnetwork 24 may service the network elements 28 of the subnetwork 24.

Links 36 may communicate data between network elements 28. Links 36 may comprise, for example, optical fibers. According to one embodiment, a link 36 may have a data communication channel (DCC) that communicates data with inband signaling. A network of data communications channels may carry too many connections, resulting in an over-subscribed channel. The over-subscribed channel may fail to communicate data over various connections.

Network management system 26 may provide network management services to monitor and maintain network 10. Network management services may include, for example, performance management, configuration management, security management, accounting management, and/or fault management services. Performance management services may measure network performance metrics in order to maintain an acceptable level of performance. Configuration management services may monitor network and system configuration information in order to track and manage the effects of hardware and software elements on network operation. Security management services may control user access to network resources in order to reduce or prevent unauthorized access. Accounting management services may measure network utilization in order to regulate user use of the network. Fault management services may detect, log, notify users of, and/or resolve network problems in order to allow the network to run effectively.

According to one embodiment, network management system 26 may use a network description of network 10 to generate a network view of network 10. The network description may describe subnetworks 24, network elements 28, and gateway network elements 32 of network 10. The network description may also describe links 36 that couple adjacent network elements 32.

A network view may refer to any suitable output, such as visual output, that includes network information that describes network 10. Moreover, a network view may describe network 10 using any suitable symbols, such as characters (for example, text or numbers), figures, tables, and/or other symbols. Moreover, a network view may have any suitable format. For example, a network view may have a soft copy format, such as a display or a electronic file, or a hard copy format, such as a paper document.

The network view may include any suitable network information. As a first example, the information may include network element information, such as network elements 28 serviced by gateway network element 32 and/or the number of L1 associations from the gateway network element 32. As a second example, the information may include link information, such as whether the data communication channel of a link is enabled, disabled, or passed through.

The network information may be provided in any suitable manner. As a first example, the information may be provided when the view is generated and/or updated. As a second example, the information may be provided in response to a user selection. For example, a user may select a network element to obtain network element information, or may select a link to obtain network link information.

The network view may be used to select an operation to be performed on network 10. According to one embodiment, a user may select a link 36 to perform a management operation on the link. Any suitable management operation may be performed, for example, enabling and/or disabling the data communication channel of a link 36.

According to the embodiment, network management system 26 may respond to the selection of an operation in any suitable manner. Network management system 26 may present a warning to the user prior to performing the operation, and may perform the operation only if the user responds appropriately. The warning may indicate, for example, that disabling a channel of a link 36 will create a management communication failure between network elements 28 of link 36. Network management system 26 may also record results of performing the operation. For example, a change to the state of a data communication channel may be logged with a time stamp and a user identifier.

According to one embodiment, only specific users may be permitted to view certain information and/or to perform certain operations. As a first example, graphical indicators 46 may be shown to only certain users. As another example, the ability to perform management operations, for example, disabling a data communication channel, may be provided to only certain users.

According to one embodiment, the network view may resemble the diagram illustrated in FIG. 1. Modifications, additions, or omissions, however, may be made to the diagram. The diagram may include more, less, or other information. Additionally, information may be organized in any suitable manner.

According to one embodiment, network management system 26 may identify links 36 that are candidate links 42. A candidate link 42 may refer to a link 36 on which a management operation may be performed in order to manage an over-subscribed data communication network. For example, a candidate link 42 may be a link 36 with adjacent network elements serviced by different gateway network elements 32. According to one embodiment, a candidate link 42 may become a candidate link in response to enablement of the data communications channel of the link 36.

According to one embodiment, a management operation may be performed on the data communication channel of the candidate link 42 to partition subnetworks 24 serviced by the gateway network elements 32. In one case, a data communication channel of the candidate link 42 may be disabled. For example, the data communication channel of candidate link 42a may be disabled to partition subnetworks 24a and 24b. In another case, the data communication channels of candidate links 42 may be passed through a network element 28. For example, the data communication channels of candidate links 42b and 42d may be passed through network element 30a to network elements 30b and 30c partition subnetworks 24b and 24c.

According to one embodiment, network management system 26 may identify candidate links 42 in the network view. In one example, a list of candidate links 42 may be provided. In another example, a graphical identifier 46 placed at or proximate to candidate link 42 and/or network elements 28 of candidate link 42 may identify candidate link 42. A graphical identifier 46 may represent a graphical element of any suitable size, shape or color. As an example, graphical identifier 46 may represent a red flag.

Modifications, additions, or omissions may be made to network 10 without departing from the scope of the invention. The components of network 10 may be integrated or separated. Moreover, the operations of network 10 may be performed by more, fewer, or other components. For example, the operations of network management system 26 may be performed by more than one component. Additionally, operations of network 10 may be performed using any suitable logic. As used in this document, “each” refers to each member of a set or each member of a subset of a set.

FIG. 2 illustrates a method for managing an over-subscribed data communication network that may be used with network 10 of FIG. 1. The method begins at step 110, where network management system 26 accesses a network description of network 10. The network description describes the network elements 28 and links 36 of network 10. A network view of network 10 is initiated at step 114 according to the network description. The network view includes network information that describes network 10.

A link 36 between network elements 28 is selected at step 118. The gateway network element 32 of the first network element 28 is identified at step 122. The gateway network element of the second network element 28 of link 36 is identified at step 126. The gateway network element 32 may be identified from the network description.

The gateway network elements 32 may be different at step 130. A link 36 with adjacent network elements 28 serviced by different gateway network elements 32 may be considered a candidate link 42. A management operation may be performed on a candidate link 42 in order to manage an over-subscribed data communication network.

If the gateway network elements 32 are different at step 130, the method proceeds to step 132, where the selected link 36 is identified as a candidate link 42. Graphical identification of the candidate link is initiated at step 134. The graphical identification may be initiated to generate a graphical identifier 46 associated with the candidate link 42. A graphical identifier 46 may comprise, for example, a flag. The method then proceeds to step 138. If the graphical network elements 32 are not different at step 130, the method proceeds directly to step 138.

There may be a next link 36 at step 138. If there is a next link 36, the method returns to step 118 to select the next link 36. If there is no next link 36, the method proceeds to step 142.

Management operations to manage the candidate links 42 may be presented at step 142. The management operations may include a operation to disable or to pass through the data communication channel of one or more links 36. A request to perform the management operation is received at step 146. The management operation is performed at step 150 in response to the request. The management operation may partition subnetworks 24 to manage the over-subscribed data communication network.

The process may be continued at step 154. The process may be continued if, for example, network 10 has not been sufficiently partitioned or one or more partitioned subnetworks 24 are still over-subscribed. If the process is to be continued at step 154, the method returns to step 118 to continue the process. Steps 118 through 138 may be performed to update the network view to show the remaining candidate links 42, and steps 142 through 140 may be performed to manage the remaining candidate links 42. If the process is not to be continued at step 154, the method terminates.

Modifications, additions, or omissions may be made to the method without departing from the scope of the invention. The method may include more, fewer, or other steps. Additionally, steps may be performed in any suitable order.

Certain embodiments of the invention may provide one or more technical advantages. A technical advantage of one embodiment may be that a network management system may initiate graphical identification of candidate links at which a network may be partitioned. The network may be partitioned in order to manage an over-subscribed data communication network.

Another technical advantage of one embodiment may be that a link with adjacent network elements that are serviced by different gateway network elements may be identified as a candidate link. Such candidate link may provide an effective point at which to partition the network.

Another technical advantage of one embodiment may be that a user may be provided with an option to manage candidate links. As an example, the user may be able to request that a data communication channel of a candidate link be disabled to partition the network. As another example, the user may be able to request that the data communication channels of candidate links be passed through a network element to partition the network.

While this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A method for managing a network, comprising:
accessing a network description of a network, the network comprising a plurality of links;
initiating generation of a network view of the network according to the network description;
identifying one or more candidate links of the plurality of links, a candidate link representing a link that is a candidate for partitioning the network; and
initiating graphical identification of the one or more candidate links.

2. The method of claim 1, wherein identifying the one or more candidate links of the plurality of links further comprises identifying that a link is a candidate link by:
determining a first gateway network element servicing a first network element of the link;
determining a second gateway network element servicing a second network element of the link, the second network element adjacent to the first network element; and
identifying the link as a candidate link if the first gateway network element is different from the second gateway network element.

3. The method of claim 1, further comprising:
providing an option for a management operation to be performed on at least one candidate link of the one or more candidate links.

4. The method of claim 3, wherein:
the management operation comprises a management operation to be performed on a data communication channel of the at least one candidate link.

5. The method of claim 3, wherein:
the management operation comprises a disable operation to disable a data communication channel of the at least one candidate link.

6. The method of claim 3, wherein:
the management operation comprises a pass-through operation to pass a plurality of data communication channels of a plurality of candidate links of the at least one candidate link through a network element.

7. The method of claim 1, further comprising:
receiving a request to perform a management operation on at least one candidate link of the one or more candidate links; and
performing the management operation on the at least one candidate link in response to receiving the request.

8. The method of claim 1, further comprising:
presenting network information in the network view.

9. A network management system for managing a network, comprising:
a memory operable to:
store a network description of a network, the network comprising a plurality of links; and
one or more processors coupled to the memory and operable to:
initiate generation of a network view of the network according to the network description;
identify one or more candidate links of the plurality of links, a candidate link representing a link that is a candidate for partitioning the network; and
initiate graphical identification of the one or more candidate links.

10. The system of claim 9, the one or more processors operable to identify the one or more candidate links of the plurality of links further comprises identifying that a link is a candidate link by:
determining a first gateway network element servicing a first network element of the link;
determining a second gateway network element servicing a second network element of the link, the second network element adjacent to the first network element; and
identifying the link as a candidate link if the first gateway network element is different from the second gateway network element.

11. The system of claim 9, the one or more processors further operable to:
provide an option for a management operation to be performed on at least one candidate link of the one or more candidate links.

12. The system of claim 11, wherein:
the management operation comprises a management operation to be performed on a data communication channel of the at least one candidate link.

13. The system of claim 11, wherein:
the management operation comprises a disable operation to disable a data communication channel of the at least one candidate link.

14. The system of claim 11, wherein:
the management operation comprises a pass-through operation to pass a plurality of data communication channels of a plurality of candidate links of the at least one candidate link through a network element.

15. The system of claim 9, the one or more processors further operable to:
receive a request to perform a management operation on at least one candidate link of the one or more candidate links; and
perform the management operation on the at least one candidate link in response to receiving the request.

16. The system of claim 9, the one or more processors further operable to:
present network information in the network view.

17. Logic for managing a network, the logic embodied in a medium and when executed by a computer operable to:
access a network description of a network, the network comprising a plurality of links;
initiate generation of a network view of the network according to the network description;
identify one or more candidate links of the plurality of links, a candidate link representing a link that is a candidate for partitioning the network; and
initiate graphical identification of the one or more candidate links.

18. The logic of claim 17, wherein identifying the one or more candidate links of the plurality of links further comprises identifying that a link is a candidate link by:
determining a first gateway network element servicing a first network element of the link;
determining a second gateway network element servicing a second network element of the link, the second network element adjacent to the first network element; and
identifying the link as a candidate link if the first gateway network element is different from the second gateway network element.

19. The logic of claim 17, further operable to:
provide an option for a management operation to be performed on at least one candidate link of the one or more candidate links.

20. The logic of claim 19, wherein:
the management operation comprises a management operation to be performed on a data communication channel of the at least one candidate link.

21. The logic of claim 19, wherein:
the management operation comprises a disable operation to disable a data communication channel of the at least one candidate link.

22. The logic of claim 19, wherein:
the management operation comprises a pass-through operation to pass a plurality of data communication channels of a plurality of candidate links of the at least one candidate link through a network element.

23. The logic of claim 17, further operable to:
receive a request to perform a management operation on at least one candidate link of the one or more candidate links; and
perform the management operation on the at least one candidate link in response to receiving the request.

24. The logic of claim 17, further operable to:
present network information in the network view.

25. A system for managing a network, comprising:
means for accessing a network description of a network, the network comprising a plurality of links;
means for initiating generation of a network view of the network according to the network description;
means for identifying one or more candidate links of the plurality of links, a candidate link representing a link that is a candidate for partitioning the network; and
means for initiating graphical identification of the one or more candidate links.

26. A network management system for managing a network, comprising:
a memory operable to:
store a network description of a network, the network comprising a plurality of links; and
one or more processors coupled to the memory and operable to:
initiate generation of a network view of the network according to the network description;
identify one or more candidate links of the plurality of links, a candidate link representing a link that is a candidate for partitioning the network, a link identified as a candidate link by:
determining a first gateway network element servicing a first network element of the link;
determining a second gateway network element servicing a second network element of the link, the second network element adjacent to the first network element; and
identifying the link as a candidate link if the first gateway network element is different from the second gateway network element;
initiate graphical identification of the one or more candidate links;
provide an option for a management operation to be performed on at least one candidate link of the one or more candidate links, the management operation comprising at least one of:
a disable operation to disable a data communication channel of the at least one candidate link; and
a pass-through operation to pass a plurality of data communication channels of a plurality of candidate links of the at least one candidate link through a network element;
receive a request to perform a management operation on at least one candidate link of the one or more candidate links;
perform the management operation on the at least one candidate link in response to receiving the request; and
present network information in the network view.
